(19) United States
(12) Patent Application Publication
(10) Pub. No.: US 2005/0148337 A1
(43) Pub. Date: Jul. 7, 2005

(54) Method and arrangement for network load regulation

(76) Inventors: Bernt Karlsson, Sollentuna (SE); Niklas Gustafsson, Grenoble (FR)

Correspondence Address: ERICSSON INC., 6300 LEGACY DRIVE, M/S EVR C11, PLANO, TX, 75024, US

(21) Appl. No.: 10/496,737

(22) PCT Filed: Nov. 30, 2001
(86) PCT No.: PCT/SE01/02666

(51) Int. Cl. H04Q 7/20

(52) U.S. Cl. 455/453

(57) ABSTRACT

The present invention relates to a method in communication networks comprising an automatic load regulation method for the network nodes. A load regulation of a controlled node to a desired load is achieved by means of a comparison of the number of call setup attempts per second during a regulation period for a given load and the allowable number of calls for a desired load. Preventive or regular call restriction measures and measures that release said restrictions are initiated depending on the deviation of the number of calls for the desired load from said number of call setup attempts for the given load. Call regulations for terminating calls are distributed to adjacent nodes by means of call gap arguments that specify minimum time intervals between consecutive call attempts from an adjacent node. Call regulations for originating calls are distributed amongst the various MS-groups and Location Areas of the controlled node.

### FIELD OF THE INVENTION

The present invention relates to a method in communication networks, in particular to a mobile telephone system, comprising an automatic load regulation method for the network nodes.

### BACKGROUND OF THE INVENTION

Communication networks are designed to be capable to handle a certain traffic load which is caused on the one hand by user-related traffic, e.g. on communication connections for voice and various types of data transmission, and on the other hand for control and signalling traffic in the network. There is however always a risk for network overload in one or more network nodes due to unexpected or temporary increases of the network traffic. The negative effects of such an overload can be reduced by help of various network management functions including certain means for overload control.

When a switching node in a communication network experiences an overload it may signal to its adjacent node that there is a high processor load or a processor overload. The adjacent node may react on this information by initiating a response program to reduce the traffic density towards the affected node. One possible regulation and control method is ‘call gapping’ as disclosed, e.g., in U.S. Pat. No. 5,060,258. ‘Call gapping’ implies that a controlled node requires certain predefined minimum time gaps between successive call attempts from each of its adjacent nodes. If the time gap is longer than the average time between two incoming call accesses, e.g. from the PLMN or PSTN to said node, this insertion will decrease the average call intensity by means of rejecting or delaying incoming call requests that follow too close in time on a previous call request to the same destination. The ‘call gapping’ method allows thus that a network node has full control of the maximum traffic intensity level that is sent to it such that a processor overload followed by call rejects will not appear. In order to be able to efficiently regulate the call intensity the nodes must provide information about the minimum length of a ‘call gap’ that will result in an acceptable processor load for said node. Today, there are only two types of indications sent back to the adjacent node: One indication refers to a high processor load and the other refers to a processor overload. When receiving such an indication a predefined response program is started by the adjacent node where the ‘call gap’ length is pre-set by a network operator command.

### SUMMARY OF THE INVENTION

A shortcoming of the prior-art solution as presented above results from the fact that the pre-set call gap lengths are statically defined and, thus, not optimal for all nodes and at each point in time. It is, however, not possible to dimension the call gap length in advance in order to be efficient for various processor load situations: Regarding, e.g., the case that the offered call intensity from the adjacent nodes is far beyond the acceptable load that a node can process or in case of higher prioritised traffic, a longer call gap length than the predefined one would be desirable. On the other hand, as long as the offered call intensity from the adjacent nodes is below the capacity limit of the node a shorter call gap length would already be sufficient and the predicted call gap length decreases the load more than necessary.

Therefore, it is an object of the present invention to achieve a method and an arrangement that allow a dynamic load control of network nodes while at the same time maintaining the network performance as experienced by the majority of user equipments in said network.

Briefly, these objects are accomplished by the method according to the present invention providing the steps of introducing regulation periods within which a load regulation of a controlled node to a desired load is achieved by means of a comparison of the number of call setup attempts per second during the regulation period for a given load and the allowable number of calls for a desired load. Preventive or regular call restriction measures and, accordingly, measures that release said restrictions are initiated depending on the deviation of said allowed number of calls for the desired load from said number of call setup attempts for the given load. Call regulations for terminating calls are distributed to adjacent nodes by means of call gap arguments that specify minimum time intervals between consecutive call attempts from an adjacent node. Call regulations for originating calls are distributed amongst the various MS-groups and Location Areas of the controlled node.

It is a first advantage of the present invention that an overload in a controlled node can be avoided already before the overload situation occurs.

It is another advantage of the present invention that call restrictions due to a load reduction are distributed in a predefined and controlled way amongst terminating and originating calls to and from the controlled node.

It is yet another advantage of the present invention that the node capacity is efficiently used on successful call attempts and not wasted by rejecting large amounts of call attempts.

It is still another advantage of the present invention that the load of nodes in a network can be dynamically controlled.

Other objects, advantages and novel features of the invention will become apparent from the following detailed description of the invention when considered in conjunction with the accompanying drawings and claims.

### BRIEF DESCRIPTION OF THE DRAWINGS

For a better understanding, reference is made to the following drawings and preferred embodiments of the invention.

FIG. 1 shows a part of a radio communication network within which the method according to the present invention could be applied.

FIGS. 2a and 2b show an overview of the various steps that are performed by the method according to the present invention.

FIGS. 2c and 2d show in greater detail the method steps for initiating call restriction measures and call admission measures respectively.

FIG. 2e shows the method steps for maintaining present restriction measures.

FIGS. 2f and 2g show in greater detail the method steps that are performed to achieve regular and preventive call restrictions in a controlled node respectively.

FIG. 2h show the method steps for a phlegm control that can be included to control the sensitivity of the load regulation part of the method according to the present invention.

FIG. 3 shows a node in a communication network comprising means to perform the method according to the present invention.

### DETAILED DESCRIPTION

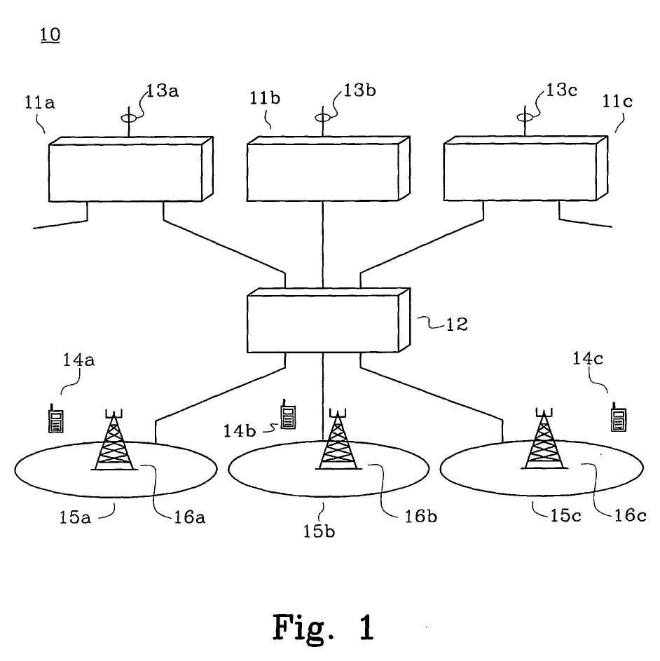

FIG. 1 shows a part of a radio communication network 10 within which the method according to the present invention can be performed. Said network is represented by four nodes 11a-11c,12 providing communication connections between each others and possibly connections 13a-13c to external networks, e.g. a Public Land Mobile Network or a Public Switched Telephone Network. A node 12 provides communication services to the user equipments 14a-14c in a number of Location Areas 15a-15c. For these purposes, a node 12 handles terminating calls from an adjacent node that are destined to a user equipment 14a-14c that is served by said node 12 and handles originating calls that are originated by one of said user equipments 14a-14c that are served by the node 12. The present invention addresses the processor load in a node 12 that is caused by these calls and call attempts to and from node 12. Said user equipments 14a-14c exchange information with the network via Radio Base Stations 16a-16c that are connected to a dedicated network node 12. The method according to the present invention as described in the following will by means of example refer to one of the nodes 12 as the controlled node M0 while the other nodes 11a-11c are regarded as adjacent nodes. However, the load regulation method according to the present invention is not restricted to, e.g., any kind of radio communication system but could also be applied in other types of networks consisting of interconnected nodes comprising connected user equipments that generate communication traffic and receive communication traffic from other nodes. The following method focuses on restriction measures for cases where the desired processor load L* in a node is less than the actual load L and measures to release such restrictions if L* is larger than L.

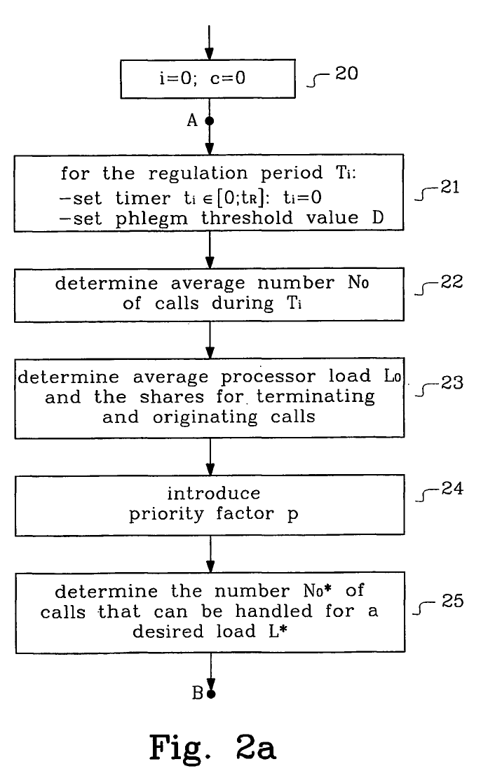

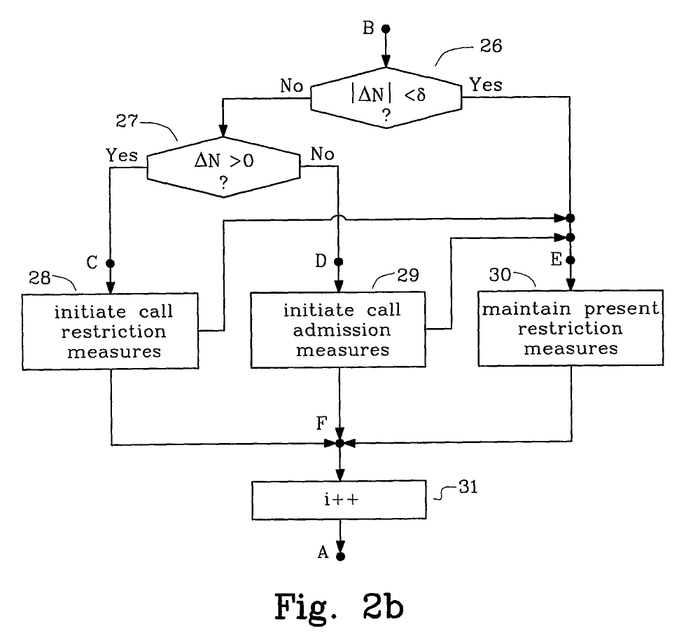

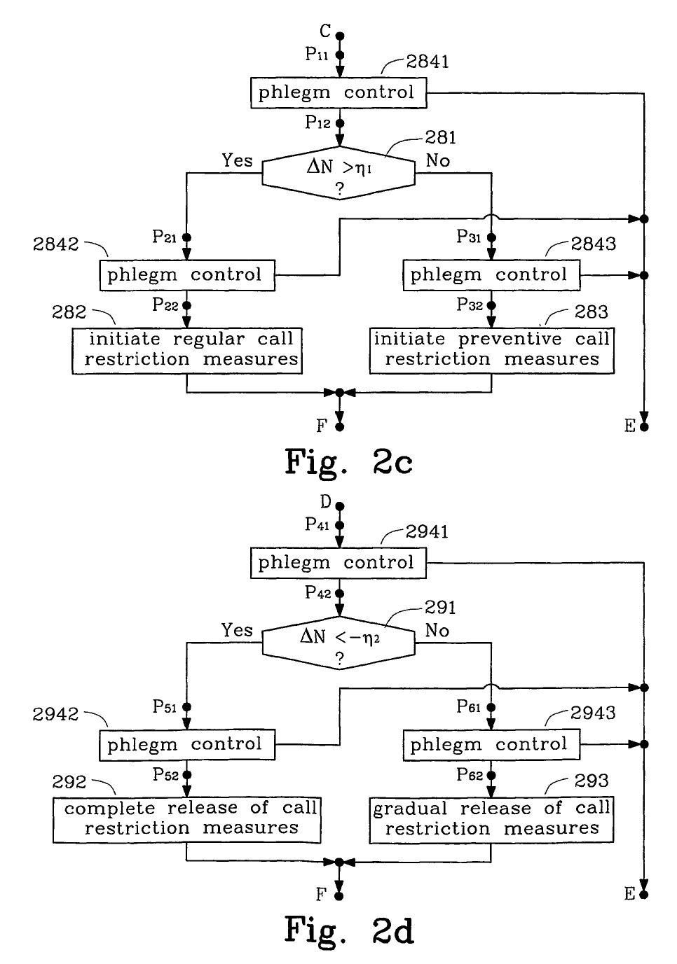

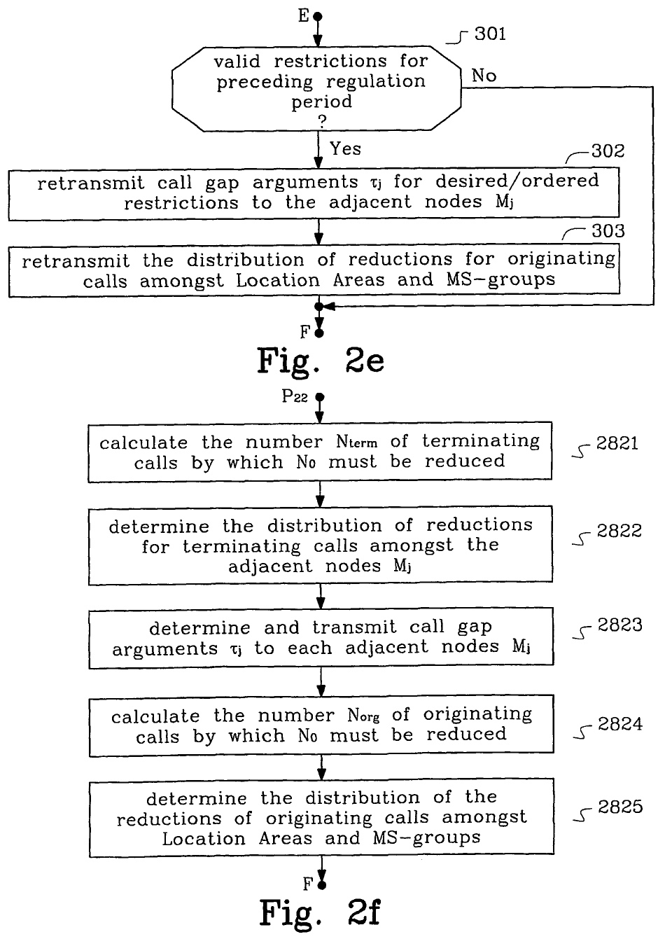

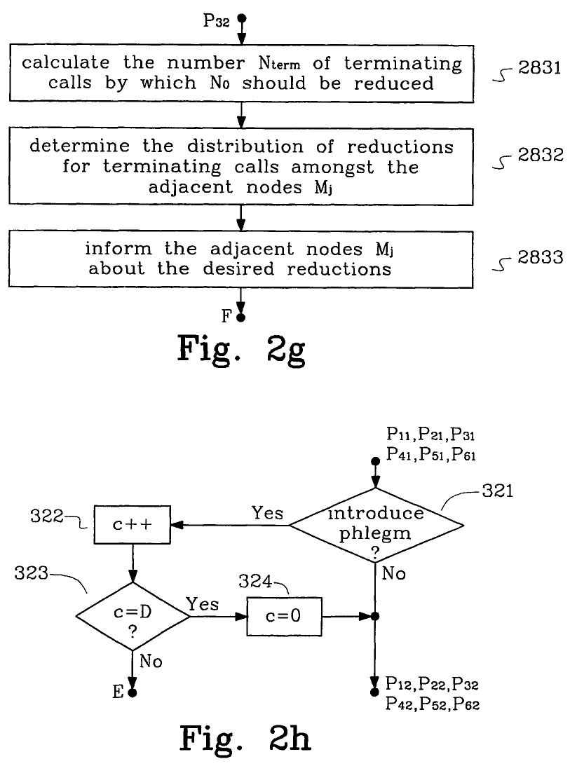

The following FIGS. 2a-2h will now describe the method according to the present invention. Said method steps are performed for at least some of a number of controlled nodes, e.g. M₀, in a communication system as presented in FIG. 1. The method is performed during so called regulation periods Tᵢ of an operator-definable length t_{R}, which is chosen, e.g., from a range of some seconds, block 21. The sensitivity for load regulation measures that may be initiated for each regulation period can be controlled by help of a threshold value D of a phlegm counter c that controls after how many times a detected overload leads to restriction measures. Said threshold value D can be defined as a common value for all regulation periods, e.g. D=3, but this value can be reconsidered at each period, block 21. At the very start of the algorithm the counter i for the regulation period and the counter c for the phlegm, if applied, are set to zero, block 20. The following description of the inventive method will now refer to a node M₀ as the controlled node. It is the object of said method to keep the load of a controlled node at a certain desirable level L*. This is achieved on the one hand by means of providing information to the adjacent nodes on call gap times between successive calls, which implies a regulation of terminated calls to the controlled node and, on the other hand, by means of restricting the number of calls amongst the Location Areas and MS-groups of the controlled node, which implies a regulation of originated calls from the controlled node. At the start of a new regulation period a timer tᵢ, which is valid for a time interval [0;t_{R}] is set to zero, block 21. Then, block 22, during said regulation period the method determines the actual load conditions of the node by means of determining the average number N₀ of calls per second during t_{R} for the controlled node, which is composed of a number N_{0,term} of terminating calls and a number N_{0,org} of originating calls. When defining aⱼₜ as the number of incoming terminating call attempts per second from the adjacent nodes Mⱼ (j=1 . . . J) and bₜ as the number of originated call attempts per second by the controlled node M₀ said total number can be calculated as

$${N}_{0} = {N}_{0 , term} + {N}_{0 , org} = \frac{1}{{t}_{R}} {\sum }_{t = 0}^{{t}_{R}} ( {\sum }_{j = 1}^{j} {a}_{jt} + {b}_{t} ) .$$

The corresponding average processor load L₀ for this number of calls can be expressed in terms of a share of the processor load Lₜₑᵣₘ that is caused by the terminating calls and a share L_{org} that is caused by the originating calls, block 23. Starting from these conditions the following steps will calculate possibly necessary adjustments of the number of terminating and originating calls in order to achieve a desired load level L* for the controlled node M₀.

Regarding said adjustments it is possible to introduce a priority factor p, e.g., from a range between [0;1], block 24, which offers the possibility to perform said adjustments either in such a way that the current traffic mix relation for originating and terminating calls is maintained or in such a way that, e.g., a network operator can apply certain regulations in favour to one of said call types. If the current traffic mix shall be maintained said priority factor p is defined to

$$p = \frac{{L}_{org}}{{L}_{org} + {L}_{term}} .$$

However, the priority factor p could also be set manually. For instance, a value p=0.75 would imply that 75% of all processed calls should be originating and 25% should be terminating calls. Another possible approach would be to set p in such a way that originating and terminating calls use the same amount of the available processor capacity.

The next step, block 25, calculates the total number N₀* of call attempts that can be handled by the controlled node M₀ for a desired load L*. In the following, L_{org,1} is defined as the load that is caused by one single originating call and, correspondingly, L_{term,1} as the load that is caused by one single terminating call. It is a first possibility to perform the calculation of N₀* with respect to the percentages of the desired processor load L* that shall be used for terminating and originating calls respectively. Then, N₀* corresponds to the sum of the numbers N_{0,org}* and N_{0,term}* of terminating and originating calls, which can be handled for the assigned load shares, i.e.

$${N}_{0}^{*} = {N}_{0 , org}^{*} + {N}_{0 , term}^{*} = p \frac{{L}^{*}}{{L}_{org , 1}} + ( 1 - p ) \frac{{L}^{*}}{{L}_{term , 1}} .$$

Another possibility, which is the preferred embodiment of the present invention, is to perform the calculation of N₀* with respect to the percentages for the number of terminating and originating calls that can be handled for the desired load L*, i.e.
N₀*=N_{0,org}+N_{0,term}*=pN₀^{*+(}1−p)N₀*.
In this case L* can be expressed as a weighted sum of the share of N₀* for originating calls N₀*·L_{org,1} and the share of N₀* for terminating calls N₀*·L_{term,1}, i.e.,
L*=pN₀*L_{org}+(1−p)N₀*L_{term,1},
and, apparently, the total number N₀* of calls that can be handled for a desired load L* corresponds to

$${N}_{0}^{*} = \frac{{L}^{*}}{{pL}_{org , 1} + ( 1 - p ) {L}_{term , 1}} .$$

A need for load restrictions in the controlled node M₀ in order to achieve a certain desired load L* is revealed by a comparison of the number of calls that are handled for the actual load L and the number of calls that could be handled for a desired load L*. Therefore, the relative deviation of the adjusted number of calls for a desired load L* from the measured number of calls for the actual load L can be applied as the criterion that initiates various grades of call restriction measures for said node. There are two options to define said deviation: In the preferred embodiment of the method according to the present invention, the relative deviation ΔN is calculated from the difference between the total number N₀ of terminating and originating calls and the number N₀* of calls that could be handled for the desired load L*, i.e.

$$Δ N = \frac{{N}_{0} - {N}_{0}^{*}}{{N}_{0}} .$$

Alternatively, in order to be able to consider, e.g., various behaviours of the terminating and originating calls it would be possible to define a restriction criterion that applies both the deviation ΔNₜₑᵣₘ for terminating calls and the deviation ΔN_{org} for originating calls with regard to the desired load L*, i.e.

$$Δ {N}_{term} = \frac{{N}_{0 , term} - {N}_{0 , term}^{*}}{{N}_{0 , term}} and Δ {N}_{org} = \frac{{N}_{0 , org} - {N}_{0 , org}^{*}}{{N}_{0 , org}} .$$

For this alternative the following steps referring to ΔN must be performed for both ΔNₜₑᵣₘ and ΔN_{org}. Apparently, as a value ΔN>0, block 27 Yes, implies that the number N₀* of calls for the desired load L* is less than the determined average number N₀ of calls per second during t_{R}, it is necessary to restrict the number of calls. A value ΔN<0, block 27 No, on the other hand implies that the controlled node could handle a number N₀* of calls that exceeds the determined number N₀, i.e. it is possible to admit additional calls for this node, e.g., by means of releasing present restriction measures.

In case of very narrow deviations |ΔN|<δ, block 26 Yes, it is not recommendable to initiate any kind of load regulation measures for the present regulation period due to the insignificance of such a deviation. The threshold value δ≧0, which denotes the size of such an optional tolerance interval can be defined, e.g., as

$$δ = \frac{{N}_{0} - {N}_{0}^{*}}{{N}_{0}} = 0.05 .$$

However, it is in this case nevertheless necessary to maintain the restriction measures that have been valid during the preceding regulation period, block 30. This is illustrated by means of FIG. 2e. If there has been valid restriction measures during the preceding regulation period, block 301 Yes, the inventive method will retransmit these restrictions. The determination of these restrictions will be explained in more detail in connection with FIGS. 2f and 2g. Regarding terminating calls the call gap arguments τⱼ, which have been determined during the preceding regulation period, are retransmitted to the adjacent nodes Mⱼ block 302. This is done both for ordered measures, e.g., due to regular restriction measures, block 282, or in consequence of a gradual release of restrictions, block 293, and for desired restrictions, e.g. in connection with preventive restriction measures, block 283. Regarding originating calls it is necessary to retransmit the distribution of reductions for these calls amongst Location Areas and MS-groups. If there are no valid regulation measures, block 301 No, e.g. because all restriction measures have been released, block 292, the method will not initiate any actions at that stage.

For |ΔN|>δ, i.e. values of ΔN outside said tolerance interval, block 26 No, the inventive method may provide different alternatives of call restriction measures, block 28, if the relative deviation ΔN exceeds the threshold value +δ, block 27 Yes, or call admission measures, block 29, if the relative deviation is below the threshold value −δ, block 27 No. Finally, block 31, the counter i for the regulation period Tᵢ is incremented and the load regulation mechanism can start again.

FIG. 2c will now describe the method steps for initiating call restriction measures, block 28. The grade of said restriction measures can be determined from said relative deviation ΔN compared to a threshold value η₁≧0, which is defined, e.g., as

$${η}_{1} = \frac{{N}_{0} - {N}_{0}^{*}}{{N}_{0}} = 0.15 .$$

For minor deviations, i.e. δ<ΔN<η₁, block 281 No, it might be optionally possible to initiate preventive call restriction measures, block 283, as explained in FIG. 2g. These measures can be applied, e.g., to achieve a reduction of the number of processed calls, which, however, might become effective not until several restriction periods later. For larger deviations, i.e. ΔN>η₁, block 281 Yes, the inventive method will initiate regular call restriction measures, block 28, that achieve a reduction of the total number of calls during the next regulation period. Optionally, it is possible to introduce a phlegm control 2841,2842,2843, which delays the consequences that result from the fact that a restriction criterion has been fulfilled. This will be explained later.

FIG. 2f describes in more detail the method steps to implement regular call restrictions, block 282, for terminating and originating calls. The total number of calls must be reduced by an amount (N₀-N₀*), which is composed of a number Nₜₑᵣₘ of terminating calls from all adjacent nodes and a number N_{org} of calls that originate from the controlled node. The calculation of the number Nₜₑᵣₘ of terminating calls by which N₀ must be reduced starts from the total number of terminating calls that have been received from all adjacent nodes during a regulation period including the number of terminating calls that are bound for the controlled node but not sent due to restriction measures. Nₜₑᵣₘ corresponds to this number reduced by the number N_{0,term}* of terminating calls that the controlled node can handle, block 2821, i.e. Nₜₑᵣₘ=N_{0,term}−N_{0,term}*. As explained above, N_{0,term}* can be calculated with respect to a share of the desired load L*, which shall be reserved for terminating calls, or simply as a share of the number N₀* reserved for terminating calls. In order to avoid that the regulation restricts a too large number of the terminating calls, it is optionally possible to introduce an upper threshold for the number Nₜₑᵣₘ by which the terminating calls are allowed to be restricted. This could be expressed, e.g., in terms of a share of the average number of terminating calls per second during t_{R}: Nₜₑᵣₘ<βₜₑᵣₘ·N_{0,term}. An appropriate value for βₜₑᵣₘ could be selected, e.g., from an interval [0.8;0.9], i.e. Nₜₑᵣₘ should not lead to a restriction of terminating calls that exceeds, e.g., 80% of the average number of terminating calls per second during t_{R}.

Nₜₑᵣₘ can also be expressed as a sum of shares Nₜₑᵣₘ(j)=αⱼ*Nₜₑᵣₘ, which describe the distribution of said reductions of terminating calls amongst each of the adjacent nodes Mⱼ, block 2822. Here, αⱼ denotes the ratio between the average number of incoming terminating calls from a specific adjacent node Mⱼ during a regulation period and the sum of the average numbers of incoming calls from all adjacent nodes, i.e.

$${α}_{j} = {\sum }_{t = 0}^{{t}_{R}} {a}_{jt} / {\sum }_{j = 1}^{j} {\sum }_{t = 0}^{{t}_{R}} {a}_{jt} .$$

The reduction of the number of terminating calls from an adjacent node Mⱼ is achieved by means of determining and transmitting a call gap argument τⱼ, which is interpreted by the receiving node Mⱼ as the minimum time interval between two successive calls from this node, block 2823.

$$\frac{1}{{τ}_{j}} = \frac{1}{{t}_{R}} {\sum }_{t = 0}^{{t}_{R}} {a}_{jt} - {α}_{j} {N}_{term}$$

If the distance in time between successive terminating calls from an adjacent node is not less than τⱼ the number of calls from the adjacent node will remain within the prescribed range of calls that can be accepted by the controlled node M₀.

The number N_{org} of originating calls by which N₀ must be reduced is calculated from the difference between the number of originating calls for the controlled node N₀ during a regulation period and the number N_{0,org}* of originating calls that the controlled node can handle, block 2824, i.e. N_{org}=N_{0,org}−N_{0,org}*. As already mentioned for the terminating calls, the regulation should not restrict a too large number of the calls. Therefore, in analogy to the restriction of terminating calls, it should be possible to introduce an upper threshold for the number N_{org} by which the originating calls are allowed to be restricted, which could be expressed, e.g., in terms of a share of the number of originating calls: N_{org}<β_{org}·N_{0,org}. An appropriate value for β_{org} could be selected, e.g., from an interval [0.8;0.9]. N_{org} is thus limited to a restriction of originating calls that does not exceed, e.g., 80% of the number of originating calls.

In order to spread the restrictions for originating calls such that the effects do not become too evident for certain groups of user equipments that are served by said node, call restrictions are distributed with regard to certain groups of user equipments and Location Areas, block 2825. User equipments can be gathered into certain numbers of MS-groups or MS-classes such that it is possible to achieve that specific measures only become effective for selected ones of these groups/classes. The number G of such groups varies depending on the radio network type, e.g. G=8 for PDC-networks or G=16 for GSM-networks.

N_{org} can also be expressed as

$${N}_{org} = {\sum }_{k = 0}^{K} \frac{{g}_{k}}{G} \cdot {MS}_{k} \cdot {N}_{k} ( {MS}_{k} ) .$$

The number of originating calls that must be restricted is distributed on the various Location Areas. MSₖ denotes the number of mobile stations in a Location Area and Nₖ(MSₖ) is the average number of calls per mobile station and second in the k:th Location Area. These average numbers are known from the statistics. For each Location Area it is possible to restrict a number gₖε[0;G] of MS-groups. Each mobile station is located in a certain Location Area and can belong to one of the MS-groups. Restrictions can be performed per MS-group and Location Area. It is thus necessary to find an appropriate number of Location Areas and for each of these Location Areas an appropriate number gₖ of MS-groups such that the sum term for N_{org} corresponds as good as possible to the number of originating calls that must be restricted.

FIG. 2g describes in more detail the method steps for initiating preventive call restriction measures, block 283. These measures need not to lead to immediate actions but keep track on detected deviations and try to reduce the number of processed calls by means of requesting the adjacent nodes to reduce voluntarily the number of terminating calls to the controlled node. This will probably not lead to an immediate load reduction for the controlled node M₀ but rather a successive reduction after some regulation periods. As already described above, the number Nₜₑᵣₘ of terminating calls by which N₀ must be reduced can be calculated as the difference between the total number of terminating calls that have been received from all adjacent nodes during the regulation period including the number of terminating calls that are bound for the controlled node but not sent due to preventive call restriction measures and the maximum number of terminating calls that the controlled node can handle for the desired load L*, block 2831. This can also be expressed as a share Nₜₑᵣₘ(j)=αⱼ*Nₜₑᵣₘ of reductions of terminating calls for each of the adjacent nodes Mⱼ, block 2832. Information about these shares are provided to each adjacent node Mⱼ, which are by this means requested to reduce voluntarily the number of calls that terminate in the controlled node M₀ by a number Nₜₑᵣₘ(j) of calls, block 2833. As done for regular restriction measures it is optionally possible to determine and transmit call gap arguments τⱼ to the adjacent nodes Mⱼ but on a voluntary base.

FIG. 2d will now describe the method steps for initiating call admission measures, block 29. These steps are performed in analogy to the corresponding method steps for call restriction measures. Call admission means that presently valid restrictions are released, completely or gradually, if it turns out that the number N₀* of calls that could be handled for a desired load L* exceeds the determined average number N₀ of calls per second during the regulation period t_{R}, i.e. ΔN<0. Also this case provides the option to distinguish between various grades of call admission measures by help of a threshold value η₂>0, which is defined in the same way as η₁. The value of |η₂| can be selected, e.g., slightly larger than |η₁| if call admission measures must be handled more careful than call restriction measures. For minor deviations, i.e. −η₂<ΔN<−δ, block 291 No, the present restriction level can be gradually released, block 293. This could be done, e.g., by means of releasing the present restriction level by a certain percentage, e.g. 20%. Another possibility is that the percentage by which the present restriction level is released corresponds to the ratio

$$\frac{δ - Δ N}{δ - {η}_{2}} .$$

For deviations ΔN<-η₂ call regulations are completely released, block 292. Optionally, it is possible also in this case to introduce a phlegm control 2941,2942,2943, which delays the consequences that result from the fact that an admission criterion has been fulfilled. This will be explained in the following.

In order to avoid too frequent changes of the permitted total number of terminating and originating calls with regard to a desired load L*, it might be an important option to control the sensitivity of the restriction algorithm, e.g., in order to secure that a prior regulation has fully come into effect before the next regulation is initiated. The sensitivity of the load regulation may be influenced by an appropriate choice of the threshold values δ for the tolerance interval and η₁, η₂, which denote the threshold values that distinguish the various grades for call restriction measures and call admission measures. The choice of a value for δ depends, e.g., on the decision which deviations from a desired load still are acceptable for a network operator. The choice of a value for η₁ or η₂ depends on a decision how fast the load regulation should be performed, i.e. for η₁ how fast call restriction measures should be initiated and for η₂ how fast such restrictions should be released. The exact selection of values for δ, η₁ and η₂ is a decision that is based on the network topology and experience from the behaviour of calls in an operators network.

Another option to control said sensitivity relates to the introduction of a phlegm as explained in more detail in FIG. 2h. A phlegm provides the possibility to delay appropriate restriction measures until the criterion that requires said measures has been fulfilled certain times. Within the scope of the present invention such a phlegm could be introduced at three places: When introducing the phlegm control in connection with the check whether any call restriction measures or call admission measures should be initiated, block 2841 or block 2941, a phlegm counter c is increased each time the corresponding regulation criterion is violated, i.e. ΔN>δ for call restriction measures and ΔN<δ for call admission measures. Instead of this, the phlegm control can also be introduced in connection with the check which of several grades of call restriction or call admission measures must be initiated. This implies for call restriction measures that a phlegm control is introduced for ΔN>η₁, block 2842, in order to delay regular call restriction measures and, optionally, for δ<ΔN<η₁, block 2843, in order to delay preventive call restriction measures. Correspondingly, for call admission measures a phlegm control is introduced for ΔN<-η₂, block 2942, in order to delay a complete release of call restriction measures and, optionally, for −η₂<ΔN<−δ, block 2943, in order to delay a gradual release of call restriction measures. The corresponding measures are not performed until the phlegm counter corresponds to the phlegm threshold value. In case of a phlegm delay, the phlegm control will nevertheless initiate that the presently valid restriction measures are maintained, block 30, i.e. retransmit the regulation orders from the previous regulation period for terminating and originating calls as already explained above. It might be a conceivable option in this situation to reset the phlegm counter to zero if there is no need for regulation measures during a regulation period, block 26 Yes. By this means it is possible to avoid that the number of occasional violations of the restriction criterion, which normally would be suppressed by the phlegm control, is summed up and restriction measures are initiated in connection with the violation for which the phlegm counter happens to correspond to the phlegm threshold value.

If a phlegm shall be applied, block 321 Yes, a phlegm counter c, which initially has been set to zero, block 20, is incremented, block 322, and compared to a delay threshold value D, block 323, each time the respective restriction criterion for the phlegm control has been violated. However, call restriction measures, block 282, or preventive call restriction measures, block 283, are not enforced until said restriction criterion has been violated the number of times that corresponds to the phlegm threshold value D, i.e. c=D, block 323 Yes. An appropriate value for D could be D=3. For this case the counter c is reset to zero, block 324, to start a new phlegm phase. Otherwise, the phlegm control will initiate measures to maintain the present restriction measures, block 30, or not initiate any call restriction measures.

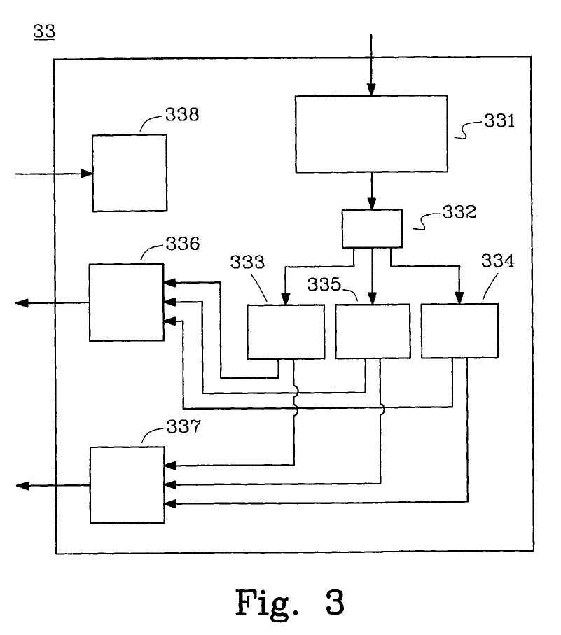

FIG. 3 shows a node 33 comprising means to perform the method according to the present invention as described above. The node 33 comprises means 331 for determining during periodic regulation periods the average number N₀ of calls that are handled by said controlled node 33 for the actual load L and the number N₀* of calls that could be handled for the desired load L*. Starting from these numbers and depending on the determined relative deviation ΔN of N₀* from N₀ as described above decision means 332 select the appropriate means for performing the regulation measures: Means 333 initiate regular or preventive call restriction measures and means 334 initiate measures to release present restrictions completely or gradually. If no measures should be performed for the present regulation period, means 335 will retransmit the regulation orders from the previous regulation period for terminating and originating calls. Regarding terminating calls from adjacent nodes means 336 are responsible to inform said adjacent nodes about call regulations by means of transmitting the calculated call gap arguments. Correspondingly, means 337 inform the MS-groups and Location Areas on regulations for originating calls. The node 33 also comprises means 338 for implementing received call regulation requests from adjacent nodes, i.e. calls that are experienced as terminating calls by an adjacent node.

1. A method of regulating a load to a desired load L* in a controlled node of a communication network having a plurality of interconnected nodes providing communication services to units that are connected to the nodes, said controlled node handling incoming traffic from adjacent nodes and traffic generated from said units, said method comprising the steps of:
determining during periodic regulation periods, the average number N0 of calls that are handled by said controlled node to produce an actual load L, and the number N0* of calls that would produce the desired load L*;
applying the relative deviation ΔN of N0* from N0 as a regulation criterion;
initiating call restriction measures if the desired load L* implies a positive value for ΔN; and
initiating call admission measures if the desired load L* implies a negative value for ΔN.

2. The method according to claim 1, wherein the call restriction measures and call admission measures are restrained or not initiated at all if the absolute value of the relative deviation |ΔN| is less than a tolerance value δ≧0.

3. The method according to claim 1, wherein the step of initiating call restriction measures includes the steps of:
initiating preventive call restriction measures if the desired load L* implies a positive value for the relative deviation ΔN that is less than or equal to a threshold value η1, said preventive call restriction measures suggesting a reduction of the number of terminating calls from said adjacent nodes; and
initiating regular call restriction measures if the desired load L* implies a positive value for the relative deviation ΔN that exceeds said threshold value η1, said regular call restriction measures requiring a reduction of the number of terminating calls from said adjacent nodes and the number of originating calls from the controlled node.

4. The method according to claim 1, wherein the step of initiating call admission measures includes the steps of:
initiating gradual call admission measures if the desired load L* implies a negative value for the relative deviation ΔN that exceeds a threshold value −η2, said gradual call admission measures releasing the present regulation level to a certain percentage; and
initiating call admission measures if the desired load L* implies a negative value for the relative deviation ΔN that is less than or equal to said threshold value −η2, said call admission measures stopping the regulation.

5. The method according to claim 4, wherein the percentage by which the present regulation level is released corresponds to the ratio
$$\frac{δ - Δ N}{δ - {η}_{2}} .$$

6. The method according to claim 4, wherein the percentage by which the present regulation level is released is manually defined.

7. The method according to claim 4, wherein the threshold value η1 for call restriction measures is less than the threshold value η2 for call admission measures.

8. The method according to claim 1, wherein the number of terminating calls is regulated by means of call gap arguments that are transmitted to the adjacent nodes in order to denote allowable minimum time intervals between consecutive call attempts to achieve a desired load contribution from said adjacent nodes.

9. The method according to claim 1, wherein the number of originating calls is regulated for a selected number of Location Areas and MS-groups to achieve a desired load contribution from the originating calls.

10. The method according to claim 1, wherein a relative deviation ΔN is determined separately for terminating calls and originating calls.

11. The method according to claim 1, wherein a priority factor can prioritise call restrictions in favour of terminating or originating calls.

12. The method according to claim 11, wherein the priority factor is manually defined.

13. The method according to claim 11, wherein the priority factor is defined so as to maintain the shares of terminated and originated calls after said load regulation measures.

14. The method according to one of the preceding claims claim 1, wherein a delay is introduced that restrains call restriction measures until the regulation criterion ΔN>0 has been valid for a given number of times and within a number of regulation periods.

15. The method according to claim 1, wherein a first delay is introduced that restrains regular call restriction measures until the regulation criterion ΔN>η1 has been valid for a given number of times and within a number of regulation periods, and a second delay is introduced that restrains preventive call restriction measures until the regulation criterion 0<ΔN<η1 has been valid for a given number of times and within a number of regulation periods.

16. The method according to claim 1, wherein a delay is introduced that restrains call admission measures until the regulation criterion ΔN<0 has been valid for a given number of times and within a number of regulation periods.

17. The method according to claim 1, wherein a first delay is introduced that restrains a complete release of call restriction measures until the regulation criterion ΔN<-η2 has been valid for a given number of times and within a number of regulation periods, and a second delay is introduced that restrains a gradual release of call restriction measures until the regulation criterion −η2<ΔN<0 has been valid for a given number of times and within a number of regulation periods.

18. The method according to claim 2, the wherein regulation orders from the previous regulation period for terminating and originating calls are retransmitted if load regulation measures are restrained.

19. A controlled node in a communication network having a plurality of interconnected nodes providing communication services to a plurality of units that are connected to said control node, wherein the controlled node handles incoming traffic from adjacent nodes and traffic generated from said units, said controlled node comprising:
means for determining during periodic regulation periods the average number N0 of calls that are handled by said controlled node to produce an actual load L, and the number N0* of calls that would produce the desired load L*;
decision means for selecting call regulation measures depending on the relative deviation ΔN of N0* from N0;
means for initiating call restriction measures, releasing present restriction measures, and retransmitting a present regulation level;
means for informing adjacent nodes about regulations for terminating calls that are bound for said controlled node and for informing Location Areas and MS-groups about regulations for originating calls from said controlled node; and
means for implementing received call regulation requests from adjacent nodes.

20. The controlled node according to claim 19, further comprising delay means that restrain call regulation measures until a regulation criterion has been violated for a given number of times and within a number of regulation periods.

21. (canceled)

22. The controlled node according to claim 19, wherein the communication network is a radio communication network.

23. The controlled node according to claim 19, wherein the communication network is a fixed communication network.

24. (canceled)
